(19) United States
(12) Patent Application Publication
(10) Pub. No.: US 2021/0387602 A1
(43) Pub. Date: Dec. 16, 2021

(54) Method for Decelerating a Motor Vehicle During Emergency Braking and Motor Vehicle

(71) Applicant: Volkswagen Aktiengesellschaft, Wolfsburg (DE)

(72) Inventor: Bastian Witte, Gross Schwülper (DE)

(73) Assignee: Volkswagen Aktiengesellschaft, Wolfsburg (DE)

(21) Appl. No.: 17/286,344

(22) PCT Filed: Oct. 14, 2019
(86) PCT No.: PCT/EP2019/077776

§ 371 Date: Apr. 16, 2021

(30) Foreign Application Priority Data
Oct. 18, 2018 (DE) 10 2018 217 808.9

(51) Int. Cl. B60T 8/92; B60T 8/176; B60T 13/74; B60T 13/16; B60T 13/66; B60T 17/22

(52) U.S. Cl. CPC B60T 8/92; B60T 8/176; B60T 13/741; B60T 13/16; B60T 2270/10; B60T 17/221; B60T 2201/03; B60T 2270/402; B60T 13/662

(57) ABSTRACT

The invention relates to a method for decelerating a motor vehicle at least during emergency braking, in which method a first braking torque is applied to at least one front wheel of the motor vehicle by means of at least one service brake system of the motor vehicle. According to the invention, at least one parking brake different from the at least one service brake system is activated by a control apparatus of the motor vehicle and a second braking torque is thereby applied to the at least one front wheel while the first braking torque is applied. A further aspect of the invention relates to a motor vehicle.

### CROSS-REFERENCE TO RELATED APPLICATIONS

This application claims priority to German Patent Application No. DE 10 2018 217 808.9, filed on Oct. 18, 2018 with the German Patent and Trademark Office. The contents of the aforesaid patent application are incorporated herein for all purposes.

### TECHNICAL FIELD

The invention relates to a method for decelerating a motor vehicle at least during emergency braking, in which method a first braking torque is applied to at least one front wheel of the motor vehicle by means of at least one service brake system of the motor vehicle. A further aspect of the invention relates to a motor vehicle, comprising a service brake system, by means of which a first braking torque can be applied to at least one front wheel of the motor vehicle, as well as at least one parking brake different from the at least one service brake system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Service brake systems of modern motor vehicles, for example passenger vehicles, often have hydraulic brakes both on a front axle and a rear axle of the motor vehicle. These hydraulic brakes are used as service brakes to effectively decelerate and thus brake the vehicle during operation, i.e. during driving. To do so, the driver of the motor vehicle actuates a brake pedal and, supported by a braking power booster, builds up hydraulic braking pressure, which acts via the service brakes on corresponding wheels of the motor vehicle assigned to the front axle or the rear axle.

To stop the motor vehicle from rolling away when it is stationary, in particular when parking on a hill, it is common to use what is known as an emergency brake. Electromechanical parking brakes (for short: EPB) are often used as emergency brakes. In this case, an electric motor actuates a self-locking gear, which usually comprises a spindle, whereby a corresponding brake pad of the service brake assigned to a wheel of the motor vehicle is pressed against a brake disk to hold this wheel in place. The self-locking gear usually converts a rotatory motion caused by the electric motor into a translational motion, for which reason the self-locking gear can also be referred to as a rot/trans gear (rotatory/translational gear). For heavy motor vehicles usually equipped with rear-wheel drive or all-wheel drive, small drum brakes are alternatively installed on the rear axle as parking brakes.

### SUMMARY

An object exists to create a method for decelerating a motor vehicle as well as a motor vehicle, by means of which the motor vehicle can be particularly effectively decelerated at least during emergency braking.

The object is solved by the subject matter of the independent claims. Embodiments are described in the dependent claims, the following description, and the drawing.

### BRIEF DESCRIPTION OF THE DRAWINGS

FIG. 1 shows a schematic representation of an example of a partial region of a motor vehicle which comprises a service brake, a parking brake, and a control apparatus.

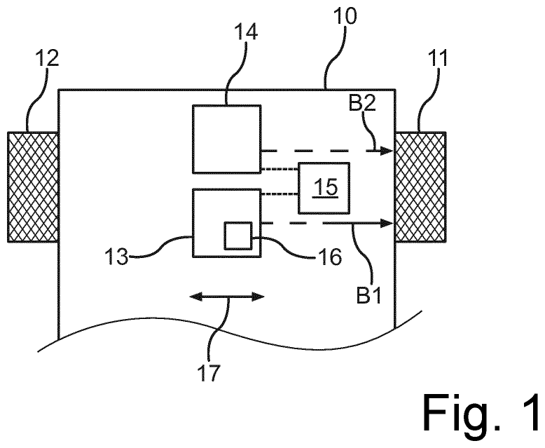

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

A first exemplary aspect relates to a method for decelerating a motor vehicle at least during emergency braking, in which method a first braking torque is applied to at least one front wheel of the motor vehicle by at least one service brake system of the motor vehicle. The service brake system serves to slow, in other words to decelerate (brake), the vehicle in normal operation, i.e., in driving operation, and bring it to a standstill as needed. The at least one front wheel may be assigned to a brake circuit of the service brake system in some embodiments. This brake circuit may also be assigned a rear wheel of the motor vehicle diagonally opposite the at least one front wheel in some embodiments, such that, by actuating the service brake system via this brake circuit, the at least one front wheel as well as the rear wheel diagonally opposite this front wheel can be braked, which may also be referred to as a diagonal split. Alternatively and in some embodiments, all of the service brakes of the service brake system assigned to one axle of the motor vehicle may also be combined to form one brake circuit, which can also be referred to as a black/white split.

According to the present exemplary aspect, at least one parking brake different from the at least one service brake system is activated by a control apparatus of the motor vehicle and a second braking torque is thereby applied to the at least one front wheel while the first braking torque is applied. This is beneficial since, as a result, the sum of the first braking torque and second braking torque acts on the at least one front wheel to brake it and thereby decelerate the motor vehicle at least during emergency braking. The motor vehicle may thereby be particularly effectively decelerated, at least during emergency braking. Just as the first braking force, the second braking force can also act as a friction force on each of at least one brake pad assigned to the at least one front wheel.

The present aspect is based on the realization that even with a modern service brake system, which may comprise, for example, a 6-piston slip control system, in the event of sudden emergency braking it can take up to 400 ms for a locking pressure of a wheel (here: of the at least one front wheel) of the motor vehicle to be reached or exceeded. When the locking pressure is reached, which may usually be at a value of, for example, 80 bar, the first braking torque resulting from the locking pressure is sufficiently high to theoretically cause a locking of the wheel (front wheel), which is a requirement for an anti-lock braking system of the motor vehicle to be activated and a maximum possible braking effect, in other words the maximum possible deceleration, of the motor vehicle to thereby be achieved. With the present aspect, the second braking torque may be applied to the at least one front wheel in addition to the first braking torque at the beginning of this duration or within this duration and at least until the locking pressure has been reached, in order to achieve a quick braking effect during emergency braking. The present aspect enables in particular an overdimensioning of the service brake system, for example in the form of an increase in a motor output of a return pump of the service brake system, if necessary in combination with an increase in a pump output of a hydraulic pump of the service brake system, to be dispensed with, which can reduce weight and costs. The present aspect is based on the further realization that the need for emergency braking only exists in particularly infrequent cases such that it is particularly expedient to apply the second braking torque to the at least one front wheel by means of the parking brake while the first braking torque is applied by the service brake system instead of implementing said overdimensioning of the service brake system.

For example, with a brake caliper assigned to the at least one front wheel, a brake piston of a wheel brake of the service brake system as well as the parking brake may act on the same brake pad provided to brake the at least one front wheel. By actuating the service brake system, the brake pad may be pressed, for example, on a brake disk to exert the first braking torque on the front wheel. The parking brake may act on the same brake pad to exert the second braking torque on the front wheel. The service brake system and the parking brake may in sum exert a pressing force on the brake pad with which this brake pad may be pressed against the brake disk at least during emergency braking to brake the front wheel. If the service brake system is operated, for example, hydraulically and the parking brake electromechanically, the pressing force may be exerted as the sum of a first clamping force applied hydraulically by means of the service brake system and a second clamping force applied electromechanically by means of the parking brake. As a result, an overall braking torque resulting from the pressing force may act on the at least one front wheel, wherein the overall braking torque is composed of the first braking torque and the second braking torque. The first braking torque may hereby result from the first clamping force, which is generated only by the service brake system, whereas the second braking torque may result from the second clamping force, which is generated only by the parking brake.

In the context of the present exemplary aspect, emergency braking is understood to mean a high deceleration of the vehicle of, for example, more than 3 m/s². Additionally or alternatively and in some embodiments, the emergency braking may exist with dynamics of the deceleration of more than 10 m/s³. The dynamics, which may also be referred to as jerk, corresponds in this case to the time derivative of the deceleration. Such large values for the deceleration and dynamics are not reached during normal driving operation.

The motor vehicle may for example be designed for autonomous driving operation. This enables a deceleration of the motor vehicle that is independent or free of manual interventions and is therefore particularly quick and effective. Thus, the motor vehicle may be operated, for example, in an “autonomy level 5” and therefore in a fully automated manner. For autonomy level 5, it is expedient, not least for reducing weight, to dispense with a brake pedal, a braking power booster of the service brake system and with corresponding components relating to a brake pedal feel in the motor vehicle. When braking (decelerating) of the motor vehicle is required, an automatic driving function of the motor vehicle, for example, may demand that the control apparatus, which may also be referred to as a brake control system, decelerates the motor vehicle. The autonomous driving operation of the motor vehicle may take place by means of the automatic driving function. The control apparatus may determine a need-based braking torque distribution for all wheel brakes of the service brake system, taking into account dynamic driving characteristics of the motor vehicle and known torque build-up dynamics of the service brake system and of the parking brake.

In some embodiments, the parking brake is deactivated again during deceleration if an intervention threshold of an anti-lock braking system of the motor vehicle is reached during the deceleration. This is beneficial since, as a result, the parking brake may be operated as needed and over a particularly short time period, namely until the first braking torque is sufficiently high in order to cause a desired deceleration of the motor vehicle without the second braking torque. Unnecessary wear and overloading of the parking brake may thereby be avoided. When the intervention threshold is reached, the anti-lock braking system (component of a first brake system) may prevent the at least one front wheel from locking.

In some embodiments, the first braking torque and the second braking torque are applied simultaneously at least at the beginning of the deceleration of the motor vehicle. This is beneficial since, as a result, a maximum possible braking effect may be achieved on the at least one front wheel particularly quickly. A temporally very quick build-up of a braking force that may be maximally transmitted by a tire of the at least one front wheel may be caused by the sum of the first braking torque and the second braking torque.

In some embodiments, the second braking torque is deactivated again after a time period, wherein the time period corresponds to a duration of 0.05 s to 2 s, for example 0.1 s to 1 s. The second braking torque may be deactivated to protect the parking brake while the first braking torque is still being exerted on the at least one front wheel. The duration of 0.05 s to 2 s is beneficial since, at this duration, an excessive load on the parking brake is avoided. With the duration of 0.1 s to 1 s, the load of the parking brake may be applied in a need-based manner. After this described time period, the first braking torque is sufficiently high to ensure the desired deceleration (braking). The support by the parking brake may no longer be required after this time period in order to protect its components (e.g. wear).

In some embodiments, the first braking torque and the second braking torque are only applied simultaneously when dynamics of a build-up of the first braking torque known to the control apparatus are lower than the dynamics of the build-up of the first braking torque demanded by an automatic driving function of the motor vehicle. The parking brake may thereby be activated in a need-based manner, wherein an unnecessary use of the parking brake, for example during braking different from the emergency braking, may be prevented and unnecessary wear of the parking brake may thereby be avoided.

In some embodiments, the parking brake is operated electrically. This allows the parking brake to be operated in a particularly user-friendly manner. The parking brake may, for example, be activated and deactivated by the control apparatus.

In some embodiments, the service brake system is operated hydraulically. This is beneficial since a particularly high brake output may be achieved using the hydraulically operated service brake system.

In some embodiments, a braking pressure used to apply the first braking torque is built up by a hydraulic return pump of the service brake system. This is beneficial since, as a result, the build-up of the braking pressure via a braking power booster may be omitted. This is in particular beneficial if the motor vehicle is designed for autonomous driving operation, for example at autonomy level 5, and accordingly does not need to have a braking power booster. The hydraulic return pump of the service brake system may be controlled by a slip control system of the motor vehicle. The slip control system may comprise an anti-lock braking system. In addition, the slip control system may comprise a traction control system and/or a control to prevent the motor vehicle from fishtailing, known as an ESP.

A second exemplary aspect relates to a motor vehicle, comprising a service brake system, by means of which a first braking torque may be applied to at least one front wheel of the motor vehicle as well as at least one parking brake different from the at least one service brake system. According to the present aspect, the motor vehicle comprises a control apparatus which is designed to detect emergency braking of the motor vehicle and, when emergency braking is detected, to activate the at least one parking brake in order to apply a second braking torque to the at least one front wheel by means of the at least one parking brake during the application of the first braking torque. This enables a particularly effective deceleration of the motor vehicle during emergency braking.

The features presented in connection with the method according to the first exemplary aspect as well as their benefits apply accordingly to the motor vehicle according to the present exemplary aspect and vice versa.

Reference will now be made to the drawing in which the various elements of embodiments will be given numerical designations and in which further embodiments will be discussed.

In the exemplary embodiments, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. It is noted that the FIG. is schematic and provided for guidance to the skilled reader and is not necessarily drawn to scale. Rather, the various drawing scales, aspect ratios, and numbers of components shown in the FIG. may be purposely distorted to make certain features or relationships easier to understand.

The only FIG. schematically shows a front end and thus a partial region of a motor vehicle 10. The motor vehicle 10 comprises a hydraulically operated service brake system 13, by means of which a first braking torque B1 may be applied to a front wheel 11 of front wheels 11, 12 of the motor vehicle 10 opposite each other in the vehicle transverse direction 17 of the motor vehicle 10. The braking torque B1 may be exerted on the front wheel 11 by means of a wheel brake (not shown here) of the service brake system 13. The vehicle 10 also comprises at least one, in the present case electrically operated, parking brake 14 different from the at least one service brake system 13, which parking brake may also be abbreviated as EPB. In addition, the motor vehicle 10 comprises a control apparatus 15 which is designed to detect emergency braking of the motor vehicle 10 and, when emergency braking is detected, to activate the parking brake 14 in order to apply a second braking torque B2 to the front wheel 11 by means of the at least one parking brake 14 during the application of the first braking torque. In the present case, the hydraulically operated service brake system 13 may be better controlled than the electrically operated parking brake 14, since control dynamics of the hydraulically operated service brake system 13 are higher than those of the electromechanically operated parking brake 14. Accordingly, the first braking torque B1 may be better controlled than the second braking torque B2.

The further front wheel 12 may be braked analogously to the front wheel 11 by means of a further parking brake (not shown here) as well as by means of a further wheel brake (not shown here) of the service brake system 13, which in the current case, however, is not described further.

To decelerate the motor vehicle 10, the first braking torque B1 is exerted on the front wheel 11 of the motor vehicle 10 by the service brake system 13 of the motor vehicle. Using the service brake system 13, each of the rear wheels (not shown here) of the motor vehicle 10 may also be braked, which in the present case, however, is not shown further. To perform the emergency braking, the parking brake 14 is activated by the control apparatus 15 of the motor vehicle 10 and the second braking torque B2 is thereby applied to the front wheel 11 while the first braking torque B1 is applied to the front wheel 11.

Emergency braking is understood to mean a high deceleration of the vehicle 10 of, for example, more than 3 m/s² accompanied by high dynamics, which may be greater than 10 m/s³, in order to prevent an accident. Such high decelerations and dynamics are not reached in normal driving operation. The motor vehicle 10 may have, for example, environment sensors, by means of which a change in distance between the driving motor vehicle 10 and an object is detected and transmitted as a corresponding signal to the control apparatus 15. Using the signal, the control apparatus 15 may evaluate whether the emergency braking is required due to the change in distance in order to prevent a collision between the object and the motor vehicle 10.

The parking brake 14 is deactivated by the control apparatus 15 as soon as the first braking torque B1 reaches an amount of torque at which, with the second braking torque B2 deactivated, the first braking torque B1 is sufficiently high to enable a desired deceleration of the motor vehicle 10 during emergency braking.

A braking pressure used to apply the first braking torque B1 may be built up by corresponding hydraulic return pumps 16 of the service brake system 13 or of a slip control system of the motor vehicle 10.

The parking brake 14 is also deactivated during deceleration if an intervention threshold of an anti-lock braking system of the motor vehicle 10 is reached during the deceleration.

The anti-lock braking system of the motor vehicle 10 ensures that the front wheel 11 does not lock, and accordingly a maximum possible deceleration may take place during emergency braking of the motor vehicle 10 by means of a controlled braking intervention using the anti-lock braking system.

With the present method or with the present motor vehicle, the parking brake 14 may be used in a need-based and effective manner during emergency braking and thus selectively in the case of need of a sudden, quick braking effect, wherein an already existing parking brake motor (EPB motor) of the electronic parking brake 14 may be operated on the front wheel 11 in parallel and thus simultaneously with the return pumps. Thus, the already existing parking brake motor, which is designed as an electric motor, may be used to actuate a brake pad and, dependent thereon, generate the second braking torque B2 on the front wheel 11 in order to at least temporarily support the return pumps in decelerating the motor vehicle 10. The sum of a first clamping force applied by actuating the service brake system 13 during emergency braking and a second clamping force applied by means of the parking brake 14 during emergency braking and thus, so to speak, the sum of hydraulic and electromechanical clamping force may then act on the brake pad. The braking torques B1, B2 result from the first and second clamping force.

An excessive load on the parking brake 14 may be avoided during emergency braking if the second braking torque B2 is deactivated as soon as the braking pressure reaches the value (pressure value) of the locking pressure, in other words the braking pressure (here: hydraulic pressure) generated by the return pump(s) is sufficiently high to theoretically cause the front wheel 11 to lock, wherein, however, the actual locking is prevented by the anti-lock braking system when the intervention threshold of the anti-lock braking system is reached. For example, the second braking force B2 acts over a time period of, for example, around 300 ms to 500 ms and is then immediately deactivated again. The first braking torque B1 and the second braking torque B2 are also only applied, for example over this time period, simultaneously when dynamics of a build-up of the first braking torque B1 known to the control apparatus 15 are lower than dynamics of the build-up of the first braking torque B1 demanded by an automatic driving function of the motor vehicle 10.

Overall, the example shows how, by means of the present teachings, the parking brake 14 is only used during driving of the motor vehicle 10 in the event of the need of emergency braking and thus only in an emergency. As a result of the fact that the parking brake 14 is only used in an emergency during driving operation of the motor vehicle 10, the probability of a failure of the parking brake 14, for example because of a malfunction of an electrical power supply, may be considerably lowered. The probability that the braking torque B2 on the front wheel 11 built up by the parking brake 14 cannot be reduced due to a self-locking of the parking brake 14 and the front wheel 11 remains braked by the parking brake 14 and thus permanently locks is correspondingly low.

### LIST OF REFERENCE NUMERALS

10 Motor vehicle
11 Front wheel
12 Other front wheel
13 Service brake system
14 Parking brake
15 Control apparatus
16 Return pump
17 Vehicle transverse direction
B1 First braking torque
B2 Second braking torque

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for decelerating a motor vehicle at least during emergency braking, in which method a first braking torque is applied to at least one front wheel of the motor vehicle by at least one service brake system of the motor vehicle, wherein at least one parking brake different from the at least one service brake system is activated by a control apparatus of the motor vehicle and a second braking torque is thereby applied to the at least one front wheel while the first braking torque is applied.

2. The method of claim 1, wherein the parking brake is deactivated again during deceleration if an intervention threshold of an anti-lock braking system of the motor vehicle is reached during the deceleration.

3. The method of claim 1, wherein the first braking torque and the second braking torque are applied simultaneously at the beginning of the deceleration of the motor vehicle.

4. The method of claim 1, wherein the second braking torque is deactivated again after a time period, wherein the time period corresponds to a duration of 0.05 s to 2 s.

5. The method of claim 1, wherein the first braking torque and the second braking torque are only applied simultaneously when dynamics of a build-up of the first braking torque known to the control apparatus are lower than dynamics of the build-up of the first braking torque requested by an automatic driving function of the motor vehicle.

6. The method of claim 1, wherein the parking brake is operated electrically.

7. The method of claim 1, wherein the service brake system is operated hydraulically.

8. The method of claim 7, wherein a braking pressure used to apply the first braking torque is built up by a hydraulic return pump of the service brake system.

9. A motor vehicle, comprising a service brake system, using which a first braking torque can be applied to at least one front wheel of the motor vehicle, and at least one parking brake different from the at least one service brake system, wherein the motor vehicle comprises a control apparatus which is configured to detect emergency braking of the motor vehicle and, when emergency braking is detected, to activate the at least one parking brake in order to apply a second braking torque to the at least one front wheel by the at least one parking brake during the application of the first braking torque.

10. The method of claim 2, wherein the first braking torque and the second braking torque are applied simultaneously at the beginning of the deceleration of the motor vehicle.

11. The method of claim 2, wherein the second braking torque is deactivated again after a time period, wherein the time period corresponds to a duration of 0.05 s to 2 s.

12. The method of claim 3, wherein the second braking torque is deactivated again after a time period, wherein the time period corresponds to a duration of 0.05 s to 2 s.

13. The method of claim 2, wherein the first braking torque and the second braking torque are only applied simultaneously when dynamics of a build-up of the first braking torque known to the control apparatus are lower than dynamics of the build-up of the first braking torque requested by an automatic driving function of the motor vehicle.

14. The method of claim 3, wherein the first braking torque and the second braking torque are only applied simultaneously when dynamics of a build-up of the first braking torque known to the control apparatus are lower than dynamics of the build-up of the first braking torque requested by an automatic driving function of the motor vehicle.

15. The method of claim 4, wherein the first braking torque and the second braking torque are only applied simultaneously when dynamics of a build-up of the first braking torque known to the control apparatus are lower than dynamics of the build-up of the first braking torque requested by an automatic driving function of the motor vehicle.

16. The method of claim 2, wherein the parking brake is operated electrically.

17. The method of claim 3, wherein the parking brake is operated electrically.

18. The method of claim 2, wherein the service brake system is operated hydraulically.

19. The method of claim 3, wherein the service brake system is operated hydraulically.

20. The method of claim 1, wherein the second braking torque is deactivated again after a time period, wherein the time period corresponds to a duration of 0.1 s to 1 s.
